(19) United States
(12) Patent Application Publication
(10) Pub. No.: US 2026/0132535 A1
(43) Pub. Date: May 14, 2026

(54) SUPERAMPHIPHOBIC COATING WITH DURABLE WEAR RESISTANCE AND CORROSION RESISTANCE FOR ALUMINUM ALLOY SURFACE AND PREPARATION METHOD THEREFOR

(71) Applicant: China Academy of Machinery Wuhan Research Institute of Materials Protection Co., Ltd., Wuhan (CN)

(72) Inventors: Dan Jia, Wuhan (CN); Ao Chen, Wuhan (CN); Yijie Jin, Wuhan (CN); Haitao Duan, Wuhan (CN); Shengpeng Zhan, Wuhan (CN); Tian Yang, Wuhan (CN); Yu Cheng, Wuhan (CN); Xiaoshuang Luo, Wuhan (CN); Jinming Ma, Wuhan (CN)

(21) Appl. No.: 19/378,807

(22) Filed: Nov. 4, 2025

(30) Foreign Application Priority Data
Nov. 13, 2024 (CN) 2024116182840

(51) Int. Cl. C25D 13/02; C09D 5/44; C25D 13/06

(52) U.S. Cl. CPC C25D 13/02; C09D 5/448; C25D 13/06

(57) ABSTRACT

A superamphiphobic coating with durable wear resistance and corrosion resistance for an aluminum alloy surface and a preparation method therefor are provided. A superamphiphobic paint includes, in parts by weight: 10-15 parts of modified SiO₂ particles, 10-15 parts of modified TiO₂ particles, 5-10 parts of PTFE, and epoxy resin matrix. The preparation method for the superamphiphobic coating includes: pre-mixing raw materials, uniformly depositing components in a pre-mixed solution on the aluminum alloy surface by electrophoresis, followed by baking to obtain the superamphiphobic coating. A superamphiphobic paint is pollution-free during production and use, and the superamphiphobic coating has high cross-linking density, low curing shrinkage rate, high wear resistance, high hardness, superhydrophobicity, and oleophobiccity. Meanwhile, by pre-treating the aluminum alloy surface, a stable and dense coating is formed to isolate oxygen, thereby improving corrosion resistance of a coated surface and providing sustainable and long-term protection for the coated surface.

### CROSS-REFERENCE TO RELATED APPLICATION

This application claims priority to Chinese Patent Application No. 202411618284.0, filed on Nov. 13, 2024, which is herein incorporated by reference in its entirety.

### TECHNICAL FIELD

The disclosure relates to the technical field of coatings, and more particularly to a superamphiphobic coating with durable wear resistance and corrosion resistance for an aluminum alloy surface and a preparation method therefor.

### BACKGROUND

Aluminum alloy has various advantages such as light weight, good thermal and electrical conductivity, good plasticity and formability, and easy processing, and has been widely used in many fields such as aerospace, automotive manufacturing, electronic manufacturing, instrument manufacturing, and light industry building materials. Especially in recent years, rapid development of Chinese industry has placed high demands on lightweighting, energy conservation, and emission reduction. Nowadays, the aluminum alloy can replace steel in many aspects and becomes a widely used metal material in industrial development. However, the aluminum alloy contains other metal elements such as magnesium (Mg) and zinc (Zn) on its surface, which are more chemically active. Especially in a marine environment rich in active chloride ions (Cl⁻) and dissolved oxygen, the other metal elements are more susceptible to corrosion, thereby severely limiting a service life and application fields of the aluminum alloy. With improvement of industrial requirements, shortcomings of the aluminum alloy, such as low hardness, poor wear resistance, and poor corrosion resistance, have become increasingly prominent. Therefore, how to effectively improve wear resistance and corrosion resistance of an aluminum alloy surface has become an important problem that urgently needs to be addressed.

Surface treatment methods in the art, such as electroplating, anodizing, and organic coating, have improved the wear resistance and corrosion resistance of the aluminum alloy to some extent, but there are still some shortcomings. For example, electroplating layers are prone to cracking during long-term use, leading to a decrease in corrosion resistance performance of the aluminum alloy. Anodized layers are prone to wear in a frictional environment. Organic coatings are prone to failure in high-temperature or strong-acid/alkali environments. In recent years, superamphiphobic surfaces, due to their unique surface wettability and ability to reduce interfacial interactions, have attracted widespread attention, especially in the fields of corrosion resistance, anti-icing, fouling resistance, and oil-water separation. Superamphiphobic coating fundamentally reduces possibility of corrosion and friction by reducing contact areas between liquids and solid surfaces, thereby preventing liquid adhesion and decreasing surface pollution. However, achieving durable wear resistance and corrosion resistance of the superamphiphobic coating on aluminum alloy surfaces remains a significant challenge.

A Chinese patent with a publication No. CN117210094A discloses a superamphiphobic composite coating with wear resistance, heat conduction, and corrosion resistance and a preparation method therefor. The superamphiphobic composite coating includes the following components in parts by weight: 8-10 parts of flake graphite, 8-10 parts of aluminum oxide (Al₂O₃), 1-3 parts of long-chain silane coupling agent, 15-20 parts of fluorine-containing resin particles, 70-80 parts of solvent, and 30-35 parts of epoxy resin. Among them, the epoxy resin is used as a film-forming substance, the fluorine-containing resin particles are used as low surface energy substances, and the long-chain silane coupling agent can improve mechanical and film-forming properties of the superamphiphobic composite coating. The superamphiphobic composite coating achieves excellent wear resistance, heat conduction, and corrosion resistance through a unique material ratio and preparation process. However, other high-performance materials such as low surface energy modified flake graphite and low surface energy modified spherical Al₂O₃ used in the preparation process of the superamphiphobic composite coating are expensive, and modification steps involved in the preparation process of the superamphiphobic composite coating are complicated, which not only increases a production cost and difficulty of technology popularization, but also may reduce a production efficiency. Therefore, this preparation method is not suitable for popularization and application.

A Chinese patent with a publication No. CN114703456A discloses a novel corrosion-resistant superhydrophobic coating on surfaces of aluminum and an aluminum alloy and a preparation method therefor. The preparation method is specifically as follows: after cleaning pretreatment, dipping, pulling and coating, and in-situ chemical curing for aluminum or the aluminum alloy, the novel corrosion-resistant superhydrophobic coating can be uniformly adhered onto the aluminum or the aluminum alloy, and bonding-force at an interface between the novel corrosion-resistant superhydrophobic coating and the aluminum or the aluminum alloy are effectively enhanced, thereby obtaining the novel corrosion-resistant superhydrophobic coating with super stability. However, existence of metal salts, such as copper, chromium, and nickel during a preparation process of the novel corrosion-resistant superhydrophobic coating may cause pollution to environment. Especially, some forms of chromium salt (such as hexavalent chromium) are highly toxic; in response to improper handling, chemical waste liquid of the chromium salt may cause serious harm to the environments. Therefore, this preparation method is not suitable for popularization and application.

### SUMMARY

To solve the aforementioned problems, the disclosure aims to provide a superamphiphobic coating with durable wear resistance and corrosion resistance for an aluminum alloy surface and a preparation method therefor.

To achieve the aforementioned objectives, technical solutions of the disclosure are as follows.

In a first aspect, the superamphiphobic coating with durable wear resistance and corrosion resistance for the aluminum alloy surface provided by the disclosure are made from the following raw materials in parts by weight: 10-15 parts of modified silicon dioxide (SiO₂) particles, 10-15 parts of modified titanium dioxide (TiO₂) particles, 5-10 parts of polytetrafluoroethylene (PTFE), and rest parts of epoxy resin matrix as a carrier. This combination can effectively provide durable corrosion-resistant, fouling-resistant, and wear-resistant properties.

An average particle size of the modified SiO₂ particles is in a range of 20 nanometers (nm) to 22 nm, and a concentration of the modified SiO₂ particles is in a range of 1 weight percent (wt %) to 1.5 wt %. An average particle size of the modified TiO₂ particles is in a range of 25 nm to 28 nm, and a concentration of the modified TiO₂ particles is in a range of 0.5 wt % to 0.6 wt %. An average particle size of PTFE powder is in a range of 200 nm to 220 nm, and a concentration of the PTFE powder is in a range of 0.5 wt % to 0.6 wt %. The modified SiO₂ particles and the modified TiO₂ particles jointly provide superhydrophobic and superoleophobic properties, and addition of the PTFE enhances the wear resistance of the superamphiphobic coating and reduces surface energy, thereby making the superamphiphobic coating have superamphiphobicity and increasing fouling resistance ability of the superamphiphobic coating.

In a second aspect, the preparation method for the superamphiphobic coating with durable wear resistance and corrosion resistance for the aluminum alloy surface provided by the disclosure includes the following steps:
S1) mixing SiO₂ nanoparticles and TiO₂ nanoparticles with a modifier individually, followed by stirring or ultrasonically dispersing to make the modifier evenly coated on surfaces of the SiO₂ nanoparticles and TiO₂ nanoparticles individually to thereby obtain a SiO₂ nanoparticle-modifier mixture and a TiO₂ nanoparticle-modifier mixture, and washing the SiO₂ nanoparticle-modifier mixture and the TiO₂ nanoparticle-modifier mixture to remove unreacted residues to thereby obtain charged SiO₂ nanoparticles and charged TiO₂ nanoparticles, namely the modified SiO₂ particles and the modified TiO₂ particles;
S2) mixing the modified SiO₂ particles in a nano-sized form, the modified TiO₂ particles in the nano-sized form, and the PTFE powder with the epoxy resin matrix to form a pre-mixed solution;
S3) treating the pre-mixed solution by ultrasonic dispersion to ensure that the modified SiO₂ particles in the nano-sized form, the modified TiO₂ particles in the nano-sized form, and the PTFE powder are evenly dispersed in the epoxy resin matrix to form a stable suspension system;
S4) uniformly depositing components in the pre-mixed solution on the aluminum alloy surface by electrophoresis: putting an aluminum alloy material performed with pre-treatment into an electrophoresis tank, adjusting appropriate electric field parameters, and uniformly depositing the charged SiO₂ nanoparticles and the charged TiO₂ nanoparticles in the pre-mixed solution on the aluminum alloy surface to form a uniform coating, to thereby obtain a coated-aluminum alloy material;
S5) removing the coated-aluminum alloy material from the electrophoresis tank, and rinsing the coated-aluminum alloy material with deionized water to remove excess sediment, to thereby obtain a prepared aluminum alloy plate; and
S6) baking the prepared aluminum alloy plate at 80 degrees Celsius (° C.) to 120° C. to cure the uniform coating, to thereby obtain the superamphiphobic coating.

In the step S2), a proportion of the raw materials is as follows: 10-15 parts of the modified SiO₂ particles, 10-15 parts of the modified TiO₂ particles, 5-10 parts of the PTFE powder, and rest 60-75 parts of the epoxy resin matrix as the carrier. The modifier is an amino silane coupling agent or a positively charged polymer. The amino silane coupling agent is one or more selected from the group consisting of 3-aminopropyltriethoxysilane, 3-aminopropyltrimethoxysilane, and N-(2-aminoethyl)-3-aminopropyltrimethoxysilane. The positively charged polymer is one or more selected from the group consisting of polyethyleneimine, polydimethyldiallylammonium chloride, and chitosan.

In the step S3), the ultrasonic dispersion is performed for 30 minutes (min) to 35 min under a power in a range of 200 watts (W) to 220 W to ensure that the modified SiO₂ particles in the nano-sized form and the modified TiO₂ particles in the nano-sized form in the pre-mixed solution are uniformly dispersed.

In the step S4), the pre-treatment for the aluminum alloy material includes surface cleaning and micro roughness treatment to increase an adhesion strength between the superamphiphobic coating and the aluminum alloy surface. A conductivity of the pre-mixed solution in the electrophoresis tank is in a range of 100 micro siemens per centimeter (μS/cm) to 110 μS/cm. An electrophoresis voltage is in a range of 50 volts (V) to 55 V. An electrophoresis duration is in a range of 10 min to 12 min.

In the step S6), a temperature during baking the prepared aluminum alloy plate is increased gradually to avoid aggregation of the modified SiO₂ particles in the nano-sized form and the modified TiO₂ particles in the nano-sized form in the pre-mixed solution due to rapid heating, thereby ensuring uniformity and performance stability of the superamphiphobic coating.

In the technical solutions of the disclosure, micro-nano structures formed by the PTFE in the superamphiphobic coating can effectively reduce friction and surface wear. Specifically, strong van der Waals forces between PTFE molecules ensure that a sliding effect can be provided when a surface of the superamphiphobic coating is subjected to friction. When the surface of the superamphiphobic coating is subjected to friction, interactions between the PTFE molecules enable a PTFE molecular layer to slide relatively easily when subjected to external forces. In addition, fluorine atoms on a PTFE surface form an almost completely smooth surface, thereby further reducing friction. The modified SiO₂ particles in the nano-sized form and the modified TiO₂ particles in the nano-sized form have better compatibility with epoxy resin, forming a dense protective layer on the surface of the superamphiphobic coating. The dense protective layer can not only block corrosive media, but also generate free radicals under ultraviolet irradiation through photocatalytic effect of TiO₂ to destroy organic matter adhered on the aluminum alloy surface, thereby further preventing corrosion from occurring. At the same time, the modified SiO₂ particles in the nano-sized form and the modified TiO₂ particles in the nano-sized form together form a multi-layered rough structure on the surface of the superamphiphobic coating, ranging from micrometer to nanometer levels. The PTFE provides necessary low surface energy. These factors work together to increase a contact angle between a droplet and the surface of the superamphiphobic coating, so water droplets and oil droplets form beads instead of spreading when contacting the superamphiphobic coating, thereby achieving effect of self-cleaning. Core innovation points of the disclosure are mainly reflected in the following aspects.
1. A material combination is innovative. The raw materials of the disclosure include the modified SiO₂ particles, the modified TiO₂ particles, the PTEF, and the epoxy resin matrix. In coatings in the art, although nano SiO₂ and nano TiO₂ have been applied to wear-resistant and hydrophobic oleophobic coatings, many researchers have not studied performance improvement brought by fine control of particle size range. The disclosure achieves an optimal micro-nano surface structure effect by optimizing particle sizes of the modified SiO₂ particles (20 nm-22 nm) and the modified TiO₂ particles (25 nm-28 nm). This combination can effectively provide long-lasting properties of corrosion resistance, fouling resistance, and wear resistance. Especially through a synergistic effect of the modified SiO₂ particles and the modified TiO₂ particles with the epoxy resin, the modified SiO₂ particles and the modified TiO₂ particles can form micro-nano rough structures on a surface of the epoxy resin due to their small particle sizes, thereby increasing a proportion of gas adhering to the surface of the superamphiphobic coating and forming a “air pocket” effect. Moreover, a combination of micro-nano structures with low surface energy materials increases contact angles of water and oil, forming a superhydrophobic and superoleophobic coating. This additional “barrier layer” increases path for corrosive media (such as water and oxygen) to penetrate below the superamphiphobic coating, thereby improving the corrosion resistance of the superamphiphobic coating. In addition, the modified SiO₂ particles in the nano-sized form and the modified TiO₂ particles in the nano-sized form have high hardness (especially TiO₂ has a high hardness). When dispersed in the epoxy resin matrix, the modified SiO₂ particles and the modified TiO₂ particles can effectively enhance hardness and wear resistance of the entire superamphiphobic coating. When the superamphiphobic coating is subjected to friction or scratching, the modified SiO₂ particles and the modified TiO₂ particles act as “barriers” to reduce surface wear of materials. Secondly, the modified SiO₂ particles and the modified TiO₂ particles can also disperse stress in the epoxy resin matrix, thereby reducing crack propagation caused by local stress concentration.
2. A preparation process is innovative. The disclosure uses electrophoresis to uniformly deposit the components in the pre-mixed solution onto the aluminum alloy surface, and through specific baking temperature and baking curing process, the superamphiphobic coating is stabilized at a lower temperature, making bonding among the modified SiO₂ particles, the modified TiO₂ particles and the epoxy resin matrix more tightly, thereby avoiding damage to material properties caused by excessive temperature and ensuring the uniformity and performance stability of the superamphiphobic coating. Compared with spray coating methods in the art, electrophoresis has significant advantages in uniformity, density, and adhesion of a coating: \textcircled{1} during an electrophoresis process, charged particles move in a fixed direction under action of an electric field and deposit on a substrate, allowing the charged particles to tightly stack with each other and reducing porosity of the coating; \textcircled{2} an electric field strength and a deposition time of an electrophoretic deposition method can be precisely controlled to obtain uniform coating thickness; due to a relatively uniform force exerted on the charged particles in the electric field, a coating thickness is uniform, an edge of the coating is smooth, and good coverage can also be achieved on surfaces with complex shapes; and \textcircled{3} electrophoretic deposition usually occurs in solution, and coating materials are gradually deposited under the action of the electric field, forming a strong interfacial bonding force. During a deposition process, the particles gradually approach the substrate, and this layer-by-layer deposition method results in higher mechanical interlocking force and higher intermolecular interactions between the coating and the substrate.
3. Performance is improved. The superamphiphobic coating provided by the disclosure has characteristics of high wear resistance, high hardness, and super hydrophobicity and oleophobicity. A stable and dense coating film can be formed by pretreating the aluminum alloy surface to isolate oxygen so as to improve corrosion resistance of a coated surface. This superamphiphobic coating can provide lasting protection in harsh environments and has important application value.
4. The superamphiphobic coating is environmentally friendly. The electrophoretic deposition method is a closed system, which can recover and deposit unused materials. Utilization rates of materials in a whole deposition process are close to 100%. Compared with surface treatment methods in the art, the superamphiphobic coating provided by the disclosure has no pollution during production and use, and a process flow is simple, which not only reduces a production cost, but also reduces impact on environments, and has good environmental friendliness.

To sum up, innovation points of the disclosure is mainly reflected in innovation of the material combination, innovation of the preparation process, improvement of the performance and environmental friendliness, etc. These innovation points together constitute an important contribution of the disclosure in the technical field of coatings.

Advantages and beneficial effects of the disclosure are as follows.

A paint provided by the disclosure is pollution-free during production and use, and the process flow is simple. The superamphiphobic coating has characteristics of high cross-linking density, low curing shrinkage rate, high wear resistance, high hardness, and super hydrophobicity and oleophobicity. Moreover, by pretreating the aluminum alloy surface, the stable and dense coating film can be formed to isolate the oxygen to improve the corrosion resistance of the coated surface, so that the coated surface can be protected by the stable and dense coating film for a long time.

### BRIEF DESCRIPTION OF DRAWINGS

FIG. 1 illustrates a view of contact angles of water and oil dropping on a superamphiphobic coating, where the water is on a left side and sunflower seed oil is on a right side.

FIG. 2 illustrates a view of change of the contact angle of the water with the superamphiphobic coating after the superamphiphobic coating is subjected to 200 cycles of friction.

### DETAILED DESCRIPTION OF EMBODIMENTS

Technical solutions of the disclosure will be further described as follows with reference to embodiments and attached drawings.

A superamphiphobic coating with durable wear resistance and corrosion resistance for an aluminum alloy surface includes the following raw materials in parts by weight: 10-15 parts of modified SiO₂ particles, 10-15 parts of modified TiO₂ particles, 5-10 parts of PTFE, and rest weight percentages of epoxy resin matrix as a carrier. This combination can effectively provide durable corrosion-resistant, fouling-resistant, and wear-resistant properties.

An average particle size of the modified SiO₂ particles is in a range of 20 nm to 22 nm, and a concentration of the modified SiO₂ particles is in a range of 1 wt % to 1.5 wt %. An average particle size of the modified TiO₂ particles is in a range of 25 nm to 28 nm, and a concentration of the modified TiO₂ particles is in a range of 0.5 wt % to 0.6 wt %. An average particle size of PTFE powder is in a range of 200 nm to 220 nm, and a concentration of the PTEF powder is in a range of 0.5 wt % to 0.6 wt %. The modified SiO₂ particles and the modified TiO₂ particles jointly provide superhydrophobic and superoleophobic properties, and addition of the PTFE enhances the wear resistance of the superamphiphobic coating and reduces surface energy, thereby making the superamphiphobic coating have superamphiphobicity and increasing fouling resistance ability of the superamphiphobic coating.

In this paint, a high-performance and multifunctional coating system is formed mainly through a synergistic effect of the PTFE, the modified SiO₂ particles, the modified TiO₂ particles, and the epoxy resin. A multi-layered rough structure formed by the modified SiO₂ particles and the modified TiO₂ particles on a surface of the superamphiphobic coating, at micrometer to nanometer level, together with the PTFE with low surface energy, can realize self-cleaning effect of the superamphiphobic coating. This characteristic is of great significance to improve durability and maintenance convenience of the superamphiphobic coating in a harsh environment.

A preparation method for the modified SiO₂ particles is specifically as follows. 100 grams (g) of SiO₂ powder is taken and placed in a vacuum drying oven for drying at 80° C. for 2 hours (h) to remove surface-adsorbed water, to thereby obtain dried SiO₂ powder. According to a volume ratio of ethanol to water of 4:1, 500 milliliters (mL) of ethanol-water solution is prepared, and a potential of hydrogen (pH) value of the ethanol-water solution is adjusted to 3.5 to 4.0 with glacial acetic acid to promote silane hydrolysis, to thereby obtain a first mixed solvent. 2.0 g of 3-aminopropyltriethoxysilane is weighed and then slowly added to the first solvent to obtain a silane solution. The silane solution is magnetically stirred at 30° C. for 30 min until the silane solution becomes clear (to generate silicon hydroxyl groups through hydrolysis), to thereby obtain a hydrolyzed silane solution. The dried SiO₂ powder is added to a three-necked flask and heated to 60° C., followed by mechanically stirred at a rotation speed of 300 revolutionary per minute (r/min). The hydrolyzed silane solution is added dropwise into the three-necked flask, and after dropwise addition is completed, a temperature in the three-necked flask is raised to 70° C. and maintained for 2 h to allow condensation reaction between the silicon hydroxyl groups and hydroxyl groups on surfaces of the SiO₂ powder. After the condensation reaction is completed, powder is collected by suction filtration and then washed three times with anhydrous ethanol to remove unreacted free silane, followed by vacuum dried at 60° C. for 4 hours, ground, and sieved through a 200-mesh sieve to thereby obtain the modified SiO₂ particles.

A preparation method for the modified TiO₂ particles is specifically as follows. 100 g of TiO₂ powder is taken and calcined in a muffle furnace at 500° C. for 2 h to remove surface organic impurities, and then cooled to room temperature, to thereby obtain calcined TiO₂ powder. According to a volume ratio of isopropanol to the water of 3:1, 400 mL of isopropanol-water solution is prepared, and a pH value of the isopropanol-water solution is adjusted to 4.0 to 4.5 with hydrochloric acid, to thereby obtain a second mixed solvent. 1.2 g of 3-glycidoxypropyltrimethoxysilane is weighed and then added into the second mixed solvent, followed by ultrasonic dispersion at 40° C. for 20 min to accelerate hydrolysis and avoid aggregation, to thereby obtain a transparent hydrolysis solution. The calcined TiO₂ powder is added to a high-pressure reactor, and the transparent hydrolysis solution is added to the high-pressure reactor, to thereby obtain a TiO₂-hydrolysis solution mixture. After sealing the high-pressure reactor, the TiO₂-hydrolysis solution mixture is heated to 80° C. and stirred at a rotation speed of 250 r/min for reaction for 1.5 h. After the reaction between the calcined TiO₂ powder and the transparent hydrolysis solution is completed, the TiO₂-hydrolysis solution mixture is cooled to the room temperature and then centrifuged at a rotation speed of 3000 r/min for 10 min to separate sediment. The sediment is washed with the isopropanol twice, followed by blow dried at 80° C. for 3 h, ground, and sieved through a 150-mesh sieve to thereby obtain the modified TiO₂ particles.

A preparation method for the superamphiphobic coating includes the following steps S1) through S5).
S1) The modified SiO₂ particles in a nano-sized form, the modified TiO₂ particles in the nano-sized form, and the PTFE powder are mixed with the epoxy resin matrix to obtain a pre-mixed solution.
S2) The pre-mixed solution is treated by ultrasonic dispersion to ensure that particles in the nano-sized form therein are uniformly dispersed.
S3) An aluminum alloy material performed with pre-treatment is put into an electrophoresis tank. Components in the pre-mixed solution are uniformly deposited on the aluminum alloy surface through electrophoresis to thereby obtain a coated-aluminum alloy material.
S4) The coated-aluminum alloy material is removed from the electrophoresis tank and then rinsed with deionized water to remove excess sediment, to thereby obtain a prepared aluminum alloy plate.
S5) The prepared aluminum alloy plate is baked and cured at 80° C. to 120° C., to thereby obtain the superamphiphobic coating.

The superamphiphobic coating prepared is subjected to a test of contact angle according to a standard GB/T 26490-2011 “Test Method for Superamphiphobic Properties of Nanomaterials”, to thereby obtain superamphiphobic performance of the superamphiphobic coating. According to a standard GB/T 10125-2012, “Corrosion Tests in Artificial Atmospheres—Salt Spray Tests”, corrosion resistance testing is conducted on a test panel coated with the superamphiphobic coating by using a neutral sodium chloride (NaCl) solution with continuous salt spray to accelerate corrosion and test. According to a standard GB/T 23988-2009 “Determination of Wear Resistance of Coatings-Falling Sand Method”, wear resistance of the superamphiphobic coating is tested by using a 1000-mesh silicon carbide (SiC) sandpaper to perform cyclic friction on a superamphiphobic coating sample under a load of 200 g, with a movement distance of 10 centimeters (cm) per cycle.

### Embodiment 1

A superamphiphobic paint I includes the following materials: 10 g of modified SiO₂ particles, 10 g of modified TiO₂ particles, 5 g of PTFE, and 60 g of epoxy resin.

A preparation method for the superamphiphobic paint I is as follows. 1) Appropriate amounts of the modified SiO₂ particles in a nano-sized form, the modified TiO₂ particles in the nano-sized form, and the PTFE are mixed with an epoxy resin matrix to obtain a pre-mixed solution. 2) The pre-mixed solution is treated by ultrasonic dispersion to ensure that particles in the nano-sized form therein are uniformly dispersed. 3) An aluminum alloy material performed with pre-treatment is put into an electrophoresis tank. Components in the pre-mixed solution are uniformly deposited on an aluminum alloy surface through electrophoresis to thereby obtain a coated-aluminum alloy material. 4) The coated-aluminum alloy material is removed from the electrophoresis tank and then rinsed with deionized water to remove excess sediment, to thereby obtain a prepared aluminum alloy plate. 5) The prepared aluminum alloy plate is baked and cured at 80° C. to 120° C., to thereby obtain a superamphiphobic coating I.

### Embodiment 2

A superamphiphobic paint II includes the following materials: 10 g of modified SiO₂ particles, 12.5 g of modified TiO₂ particles, 7.5 g of PTFE, and 67.5 g of epoxy resin.

A preparation method and a use method for the superamphiphobic paint II are the same as those in embodiment 1, to thereby obtain a superamphiphobic coating II.

### Embodiment 3

A superamphiphobic paint III includes the following materials: 10 g of modified SiO₂ particles, 15 g of modified TiO₂ particles, 10 g of PTFE, and 75 g of epoxy resin.

A preparation method and a use method for the superamphiphobic paint III are the same as those in embodiment 1, to thereby obtain a superamphiphobic coating III.

### Embodiment 4

A superamphiphobic paint IV includes the following materials: 12.5 g of modified SiO₂ particles, 10 g of modified TiO₂ particles, 7.5 g of PTFE, and 75 g of epoxy resin.

A preparation method and a use method for the superamphiphobic paint IV are the same as those in embodiment 1, to thereby obtain a superamphiphobic coating IV.

### Embodiment 5

A superamphiphobic paint V includes the following materials: 12.5 g of modified SiO₂ particles, 12.5 g of modified TiO₂ particles, 10 g of PTFE, and 60 g of epoxy resin.

A preparation method and a use method for the superamphiphobic paint V are the same as those in embodiment 1, to thereby obtain a superamphiphobic coating V.

### Embodiment 6

A superamphiphobic paint VI includes the following materials: 12.5 g of modified SiO₂ particles, 15 g of modified TiO₂ particles, 5 g of PTFE, and 67.5 g of epoxy resin.

A preparation method and a use method for the superamphiphobic paint VI are the same as those in embodiment 1, to thereby obtain a superamphiphobic coating VI.

### Embodiment 7

A superamphiphobic paint VII includes the following materials: 15 g of modified SiO₂ particles, 10 g of modified TiO₂ particles, 10 g of PTFE, and 67.5 g of epoxy resin.

A preparation method and a use method for the superamphiphobic paint VII are the same as those in embodiment 1, to thereby obtain a superamphiphobic coating VII.

### Embodiment 8

A superamphiphobic paint VIII includes the following materials: 15 g of modified SiO₂ particles, 12.5 g of modified TiO₂ particles, 5 g of PTFE, and 75 g of epoxy resin.

A preparation method and a use method for the superamphiphobic paint VIII are the same as those in embodiment 1, to thereby obtain a superamphiphobic coating VIII.

### Embodiment 9

A superamphiphobic paint IX includes the following materials: 15 g of modified SiO₂ particles, 15 g of modified TiO₂ particles, 7.5 g of PTFE, and 60 g of epoxy resin.

A preparation method and a use method for the superamphiphobic paint IX are the same as those in embodiment 1, to thereby obtain a superamphiphobic coating IX.

Based on test methods described above, performance tests are conducted on superamphiphobic coatings prepared in embodiment 1 through embodiment 9, and performance test results are shown in table 1.

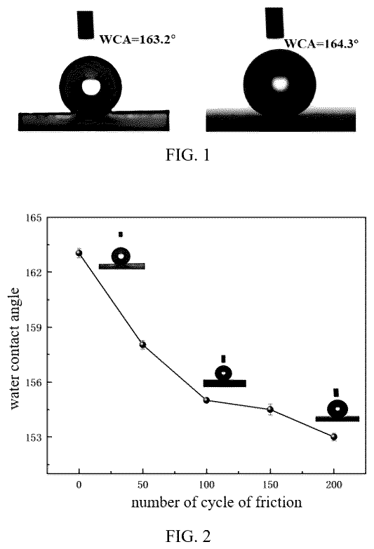

FIG. 1 illustrates a view of contact angles of water and oil (sunflower seed oil) dropping on a superamphiphobic coating. FIG. 2 illustrates a view of change of the contact angle of the water with the superamphiphobic coating after the superamphiphobic coating is subjected to 200 cycles of friction. After the superamphiphobic coating is subjected to 200 cycles of friction, a water contact angle (WCA) of the superamphiphobic coating is larger than 150 degrees) (°, and the superamphiphobic coating still maintains excellent water repellency, indicating that the superamphiphobic coating has excellent superhydrophobic performance and friction resistance.

It can be seen from the performance test results of the superamphiphobic coatings, a comprehensive performance of the superamphiphobic paint III prepared in embodiment 3 is the best. Specifically, after 200 cycles of friction, a WCA of the superamphiphobic paint III is larger than) 150° (159.4°, and no corrosion occurs on the superamphiphobic paint III after 2000 hours of salt spray test. The superamphiphobic paint III does not bubble, wrinkle, peel, or crack, and has excellent and durable hydrophobicity, oleophobicity, wear resistance, and corrosion resistance. (Test results of hydrophobicity, oleophobicity, and wear resistance are represented by values of contact angles, with wear resistance being a value of a contact angle after 200 cycles of friction; in test results of corrosion resistance, “excellent” represents no corrosion, and “good” represents a corrosion area being less than 3%).

TABLE 1
Performance test results of superamphiphobic coatings

| | | | | wear | corrosion |
|---|---|---|---|---|---|
| coating performance | | hydrophobicity | oleophobicity | resistance | resistance |
| superamphiphobic | I | 151.3 | 146.8 | 141.3 | good |
| coating | II | 154.6 | 157.2 | 147.2 | good |
| | III | 163.2 | 164.3 | 159.4 | excellent |
| | IV | 158.0 | 153.2 | 150.5 | good |
| | V | 161.2 | 156.2 | 155.0 | excellent |
| | VI | 152.3 | 157.3 | 142.1 | good |
| | VII | 159.2 | 154.7 | 148.0 | good |
| | VIII | 154.0 | 149.4 | 144.4 | good |
| | IX | 159.2 | 154.0 | 151.6 | excellent |

What is claimed is:

1. A superamphiphobic coating with durable wear resistance and corrosion resistance for an aluminum alloy surface, made from the following raw materials in parts by weight: 10 parts of modified silicon dioxide (SiO₂) particles, 15 parts of modified titanium dioxide (TiO₂) particles, 10 parts of polytetrafluoroethylene (PTFE), and 75 parts of epoxy resin matrix as a carrier;
wherein an average particle size of the modified SiO₂ particles is in a range of 20 nanometers (nm) to 22 nm; and an average particle size of the modified TiO₂ particles is in a range of 25 nm to 28 nm;
wherein an average particle size of PTFE powder is in a range of 200 nm to 220 nm;
wherein a preparation method for the superamphiphobic coating for the aluminum alloy surface comprises the following steps:
S1) mixing SiO₂ nanoparticles and TiO₂ nanoparticles with a modifier individually, followed by stirring or ultrasonically dispersing to make the modifier evenly coated on surfaces of the SiO₂ nanoparticles and the TiO₂ nanoparticles individually to thereby obtain a SiO₂ nanoparticle-modifier mixture and a TiO₂ nanoparticle-modifier mixture, and washing the SiO₂ nanoparticle-modifier mixture and the TiO₂ nanoparticle-modifier mixture to remove unreacted residues to thereby obtain charged SiO₂ nanoparticles and charged TiO₂ nanoparticles, namely the modified SiO₂ particles and the modified TiO₂ particles;
S2) mixing the modified SiO₂ particles in a nano-sized form, the modified TiO₂ particles in the nano-sized form, and the PTFE powder with the epoxy resin matrix to form a pre-mixed solution;
S3) treating the pre-mixed solution by ultrasonic dispersion to ensure that the modified SiO₂ particles in the nano-sized form, the modified TiO₂ particles in the nano-sized form, and the PTFE powder are evenly dispersed in the epoxy resin matrix to form a stable suspension system;
S4) uniformly depositing components in the pre-mixed solution on the aluminum alloy surface by electrophoresis: putting an aluminum alloy material performed with pre-treatment into an electrophoresis tank, adjusting appropriate electric field parameters, and uniformly depositing the charged SiO₂ nanoparticles and the charged TiO₂ nanoparticles in the pre-mixed solution on the aluminum alloy surface to form a uniform coating, to thereby obtain a coated-aluminum alloy material;
S5) removing the coated-aluminum alloy material from the electrophoresis tank, and rinsing the coated-aluminum alloy material with deionized water to remove excess sediment, to thereby obtain a prepared aluminum alloy plate; and
S6) baking the prepared aluminum alloy plate at 80 degrees Celsius (° C.) to 120° C. to cure the uniform coating, to thereby obtain the superamphiphobic coating; and
wherein in the step S1), the modifier is an amino silane coupling agent or a positively charged polymer.

2. The superamphiphobic coating for the aluminum alloy surface as claimed in claim 1, wherein the amino silane coupling agent is one or more selected from the group consisting of 3-aminopropyltriethoxysilane, 3-aminopropyltrimethoxysilane, and N-(2-aminoethyl)-3-aminopropyltrimethoxysilane; and the positively charged polymer is one or more selected from the group consisting of polyethyleneimine, polydimethyldiallylammonium chloride, and chitosan.

3. The superamphiphobic coating for the aluminum alloy surface as claimed in claim 2, wherein in the step S2), the ultrasonic dispersion is performed for 30 minutes (min) to 35 min under a power in a range of 200 watts (W) to 220 W to ensure that the modified SiO₂ particles in the nano-sized form and the modified TiO₂ particles in the nano-sized form in the pre-mixed solution are uniformly dispersed.

4. The superamphiphobic coating for the aluminum alloy surface as claimed in claim 3, wherein in the step S3), the pre-treatment for the aluminum alloy material comprises surface cleaning and micro roughness treatment to increase an adhesion strength between the superamphiphobic coating and the aluminum alloy surface; a conductivity of the pre-mixed solution in the electrophoresis tank is in a range of 100 micro siemens per centimeter (μS/cm) to 110 μS/cm, an electrophoresis voltage is in a range of 50 volts (V) to 55 V, and an electrophoresis duration is in a range of 10 min to 12 min.

5. The superamphiphobic coating for the aluminum alloy surface as claimed in claim 4, wherein in the step S5), a temperature during baking the prepared aluminum alloy plate is increased gradually to avoid aggregation of the modified SiO₂ particles in the nano-sized form and the modified TiO₂ particles in the nano-sized form in the pre-mixed solution due to rapid heating, thereby ensuring uniformity and performance stability of the superamphiphobic coating.
